(19) United States
(12) Patent Application Publication
(10) Pub. No.: US 2025/0037376 A1
(43) Pub. Date: Jan. 30, 2025

(54) ACCELERATED GEOMETRY PROCESSING USING PARALLEL PROCESSING SYSTEMS

(71) Applicant: NVIDIA Corporation, Santa Clara, CA (US)

(72) Inventors: Seyedamirhesam SHAHVARANI, Munich (DE); Shankara Rao Thejaswi NANDITALE, Haar (DE)

(73) Assignee: NVIDIA Corporation, Santa Clara, CA (US)

(21) Appl. No.: 18/782,980

(22) Filed: Jul. 24, 2024

Related U.S. Application Data
(60) Provisional application No. 63/515,384, filed on Jul. 25, 2023.

(51) Int. Cl. G06T 17/20; G06F 16/22

(52) U.S. Cl. CPC G06T 17/20; G06F 16/2264

(57) ABSTRACT

In various examples, systems and methods are disclosed relating to shape processing using parallel computing systems. A processor can map one or more combinations of a plurality of first polygons identified from a first structure and a plurality of second polygons identified from a second structure, to a grid comprising a plurality of cells. The processor can identify one or more occupied cells of the plurality of cells, to which the one or more combinations are mapped. The processor can output a data structure indicative of the plurality of occupied cells.

### CROSS-REFERENCE TO RELATED APPLICATION

This application claims priority to and the benefit of U.S. Provisional Application No. 63/515,384, filed Jul. 25, 2023, which is incorporated herein by reference in its entirety for all purposes.

### BACKGROUND

Determining the optimal placement of shapes on a finite, defined surface—to minimize wasted material, for example—presents a significant computational and practical challenge. This problem, known as nesting or stock cutting optimization, is a complex task that involves many variables and constraints, and it bears similarities to problems faced in other fields such as three-dimensional graphics and manufacturing. In three-dimensional graphics, analogous issues arise when mapping a two-dimensional texture onto a three-dimensional model, a process known as UV mapping, or when packing different graphical elements efficiently into a texture atlas. Both tasks demand effective strategies to utilize space as efficiently as possible while accommodating various shapes and sizes. Just as UV mapping seeks to reduce distortion and texture waste, nesting aims to maximize material utilization and minimize waste. However, finding the optimal solution for such problems is challenging.

### SUMMARY

Implementations of the present disclosure relate to systems and methods for polygon processing, including accelerating polygon processing using parallel processing systems. One or more processors or other components described herein can determine a summation (e.g., a Minkowski sum) for a combination of structures. In contrast to conventional systems, such as those described above, the systems and methods of the present disclosure can sum arbitrary structures by disaggregating those structures into constituent portions, and rasterizing combinations of the constituent portions to generate a sum of the structures. Various such solutions can improve parallelization, reduce overall compute and memory use, and otherwise improve structure summation, generation of no-fit polygons, manufacturing of components, or video graphics, among other applications.

At least one aspect relates to a processor. The processor can include one or more circuits to map one or more combinations, of a plurality of first polygons identified from a first structure and a plurality of second polygons identified from a second structure, to a grid comprising a plurality of cells. The one or more circuits can identify one or more occupied cells of the plurality of cells, to which the one or more combinations are mapped. The one or more circuits can output a data structure indicative of the plurality of occupied cells.

In some implementations, the grid is a first grid, the plurality of cells are a plurality of first cells, and the one or more occupied cells are one or more first occupied cells. The one or more circuits are to identify, in at least one second grid comprising a plurality of second cells, at least one region corresponding to the one or more first occupied cells, at least one second cell of the plurality of second cells smaller than at least one first cell of the plurality of first cells. The one or more circuits are to map the one or more combinations to one or more second cells of the plurality of second cells outside of the at least one region to identify one or more second occupied cells of the plurality of second cells outside of the at least one region. The one or more circuits are to determine the data structure according to the plurality of first occupied cells and the plurality of second occupied cells.

In some implementations, the one or more circuits comprise a plurality of first circuits to determine the plurality of combinations, wherein each of the first circuits is communicatively coupled to a second circuit to set a flag of the second circuit, the flag being indicative that a given cell is one of the plurality of occupied cells.

In some implementations, each of the plurality of occupied cells is bounded by the plurality of combinations.

In some implementations, at least one first polygon is a convex polygon, and the first structure is a non-convex polygon.

In some implementations, the one or more circuits comprise a plurality of parallel computing circuits (e.g., parallel processing circuits), each parallel computing circuit of the plurality of parallel computing circuits to independently determine a corresponding combination of the one or more combinations.

In some implementations, the grid is a three-dimensional grid, and each cell is a voxel of the three-dimensional grid.

In some implementations, the data structure represents a no-fit polygon (NFP) for arranging a plurality of parts corresponding to the first structure and the second structure.

At least one aspect relates to a system. The system can include one or more circuits to map one or more combinations, of a plurality of first polygons identified from a first structure and a plurality of second polygons identified from a second structure, to a grid comprising a plurality of cells. The circuits can identify one or more occupied cells of the plurality of cells, to which the one or more combinations are mapped. The circuits can output a data structure indicative of the plurality of occupied cells.

In some implementations, the grid is a first grid, the plurality of cells are a plurality of first cells, and the one or more occupied cells are one or more first occupied cells. The one or more circuits can identify, in at least one second grid comprising a plurality of second cells, at least one region corresponding to the one or more first occupied cells, at least one second cell of the plurality of second cells smaller than at least one first cell of the plurality of first cells. The one or more circuits can map the one or more combinations to one or more second cells of the plurality of second cells outside of the at least one region to identify one or more second occupied cells of the plurality of second cells outside of the at least one region. The one or more circuits can determine the data structure according to the plurality of first occupied cells and the plurality of second occupied cells.

The one or more circuits can include a plurality of first circuits to determine the plurality of combinations, wherein each of the first circuits is communicatively coupled to a second circuit to set a flag of the second circuit, the flag being indicative that a given cell is one of the plurality of occupied cells.

In some implementations, each of the plurality of occupied cells is bounded by the plurality of combinations.

In some implementations, at least one first polygon is a convex polygon, and the first structure is a non-convex polygon.

The one or more circuits can include a plurality of parallel computing circuits, each parallel computing circuit of the plurality of parallel computing circuits to independently determine a corresponding combination of the one or more combinations.

In some implementations, the grid is a two-dimensional grid, and each cell is a voxel of the three-dimensional grid.

At least one aspect of the present disclosure relates to a method. The method can include mapping one or more combinations of a plurality of first polygons identified from a first structure and a plurality of second polygons identified from a second structure, to a grid comprising a plurality of cells. The method further includes identifying, by the data processing system, one or more occupied cells of the plurality of cells, to which the one or more combinations are mapped. The method further includes outputting a data structure indicative of the plurality of occupied cells.

In some implementations, the grid is a first grid, the plurality of cells are a plurality of first cells, and the one or more occupied cells are one or more first occupied cells. The method can further include identifying, by the data processing system, in at least one second grid comprising a plurality of second cells, at least one region corresponding to the one or more first occupied cells, wherein at least one second cell of the plurality of second cells is smaller than at least one first cell of the plurality of first cells. The method can include mapping, by the data processing system, the one or more combinations to one or more second cells of the plurality of second cells outside of the at least one region to identify one or more second occupied cells of the plurality of second cells outside of the at least one region. The method can include determining, by the data processing system, the data structure according to the plurality of first occupied cells and the plurality of second occupied cells.

In some implementations, the method includes determining the plurality of combinations. The method can include setting a flag indicative that a given cell is one of the plurality of occupied cells.

In some implementations, each of the plurality of occupied cells is bounded by the plurality of combinations.

The processors, systems, and/or methods described herein can be implemented by or included in any system that generates a response or output based on input video data, such as at least one of a system associated with an autonomous or semi-autonomous machine (e.g., an AI driver, an in-vehicle infotainment system, and so on); a system for text-to-video modeling, a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system implementing one or more language models (e.g., large language models (LLMs), vision language models (VLMs)); a system for generating and using synthetic data; a system incorporating one or more virtual machines (VMs); a system implemented at least partially in a datacenter; or a system implemented at least partially using cloud computing resources.

### BRIEF DESCRIPTION OF THE DRAWINGS

The present systems and methods for accelerating polygon processing using parallel processing systems are described in detail below with reference to the attached drawing figures, wherein:

FIG. 1 is a block diagram of an example computing environment for shape processing.

FIG. 2 is a flow diagram of an example of a data flow to determine a summation for structures.

FIGS. 3A, 3B, 3C, and 3D are diagrams illustrating examples of an identification of various polygons corresponding to structures.

FIGS. 4A and 4B are diagrams illustrating an example of a vertex sweep function.

FIG. 5 depicts an example of rasterization of a shape summation over a grid.

FIG. 6 depicts an example of a scaled cell of a grid.

FIGS. 7A-7C depict an example of multi-level recursive rasterization of the shape summation of FIG. 5.

FIG. 8 is a block diagram of an example of a method for shape processing.

FIG. 9 is a block diagram of an example computing device suitable for use in implementing some implementations of the present disclosure.

FIG. 10 is a block diagram of an example data center suitable for use in implementing some implementations of the present disclosure.

### DETAILED DESCRIPTION

This disclosure relates to systems and methods for accelerating processing of polygons and other shape data using parallel processing systems. The shapes represented by the shape data can include, for example and without limitation, various forms of polygons, such as convex or non-convex polygons. Operations performed on shape data can be useful for planning or simulating real-world actions to be performed using the shapes.

For example, operations can be performed on polygon data for orienting or arranging shapes (e.g., polygon data representative of shapes) representing parts for manufacturing or packing actions. Complex shapes may be difficult to orient in space constrained environments. For example, it may be useful for a printer or other manufacturer to reduce or minimize unused material for a sheet material such as steel, gold foil, or paper when producing cut or stamped designs, such as by increasing or maximizing a number and/or surface area of parts over a corresponding surface of the sheet material. To optimize an arrangement of parts, it may be useful to employ various computations or algorithms for combining spatial information regarding the parts, such as to determine a sum of the shapes. This can include, for example, Minkowski summation of two or more parts to determine a number of positions two parts may occupy. Minkowski summation can be readily amenable to parallelization by generating such sums for constituent portions of the parts. However, summing operations including Minkowski summation use a union operation to rejoin the constituent portions. This can be computationally expensive, and may reduce or eliminate the advantages of parallelization.

Systems and methods in accordance with the present disclosure can obviate union operations by identifying sub-shapes from the shape data and combining the sub-shapes using fewer and/or less computationally intensive operations. This can include, for example and without limitation, using a rasterization-based approach. For example, rather than determining a union operation that merges the various constituent portions, a processor can, according to the systems and methods described herein, project the various sums over a grid or other collection of cells (e.g., pixels, voxels, toxels, or the like). The processor can thereafter indicate, for each occupied cell, that one or more of the sums occupies the cell, such as by setting a bit flag associated with the cell. By repeating the indication for each of the sums generated from various constituent portions, the processor can generate one or more aggregate sums without performing explicit union operations.

For example, a sum (e.g., Minkowski sum, etc.) of two or more shapes can be generated by an addition of one or more points (e.g., addition of vectors corresponding to the points, etc.) representing the respective shapes. A sum may be generated for various shapes, such as shapes including curved portions, concave surface, holes, and discontinuous shapes. Such sums may be useful in object nesting. For example, a sum can be used as, or to determine, a no-fit shape, defining a region of space that can include the two or more shapes without an intersection. Such shapes may be useful in software-implemented modeling of object behavior, manufacturing, storage, etc.

To facilitate more effective sum operations, it may be useful to identify a plurality of sub-shapes, such as convex polygons, from the shapes to be summed, where the sub-shapes can represent portions of the shapes that when combined form the shapes. For example, complex shapes can be disaggregated into simpler shapes, such as convex polygons (e.g., triangles). Such shapes can be defined by a limited number of vertices, such that the sum can be determined based on the vertices of two respective shapes. For example, the system can identify, from a first shape, a plurality of n polygons, and from a second shape, a plurality of m polygons. Graphically, the sum can correspond to rotating one shape around the other (e.g., using a sweep-line technique, etc.) where a first polygon is conceptually swept along lines defined between the vertices of the second polygon. By determining sums for each of the n polygons with each of the m polygons, and determining for the cells occupied by one or more of the resulting sums, a Minkowski sum of the first and second shape can be determined.

Each summation between the n and m polygons can be performed independent of other portions of the shape, and thus can be readily amendable to parallelization. For instance, for a first shape disaggregating into 500 polygons, and a second shape disaggregating into 250 polygons, each of the 125,000 (500×250) sums can be determined without data exchange between additional polygons. However, to generate an aggregate sum, the (for example, 125,000) sums are combined into an aggregate shape (e.g., a union operation) which may be computationally expensive, particularly with regard to high polygon count shapes, or higher dimensional summations (e.g., for three-dimensional space, or various phase spaces of arbitrary dimensions). For example, each of the sums for each polygon will overlap with at least adjacent polygons of the same part, and may overlap with several, according to a polygon size. For example, a portion of a shape can include several overlapping sums.

In some implementations, the system identifies one or more grids to map to or to otherwise assign shape data, such as representations of the shapes or portions thereof (e.g., sub-shapes). The grids can include a plurality of respective cells, which may have varying cell sizes (e.g., numbers of pixels corresponding to each cell in a pixel-based frame of reference). For example, a rasterizer may be used to assign respective portions of the shapes resulting from each of the sums into corresponding cells of the grids. The system can assign a value to cells to which one or more portions are assigned. A projection of the various Minkowski sums over such a grid can accomplish a union operation, since any cells occupied by any of the Minkowski sums may be included in a result. That is, each cell can perform a logical OR of the Minkowski sums written thereto. For example, the various parallel threads, circuits, or the like used for computing the Minkowski sums can set a flag when a Minkowski sum occupies a cell, such that a same flag is set for any number of Minkowski sums. That is, for a cell that is occupied by n Minkowski sums, the associated bit flag may be set n times (e.g., to a same value). For example, the flag may be a one-bit value where one of “0” or “1” indicates a flag is set and the other of “0” or “1” indicates the flag is clear.

According to some implementations, occupation of a cell may be defined as an entirety of a cell being occupied, which may generate a Minkowski sum that is somewhat smaller than an algebraically generated Minkowski sum, wherein cells which are intersected by a polygon but not bounded by the polygon are truncated. According to some implementations, occupation of a cell may be defined based on any portion of the cell being occupied (e.g., including a cell intersected by a polygon) which may generate a Minkowski sum which is somewhat larger than an algebraically generated Minkowski sum.

Because many shapes may overlap, determining aggregations of cells which can be verified, written, or the like by an atomic operation may reduce inter-thread contention, memory usage, or a number of times an occupancy of a cell is determined, which may in turn lower a power use for a circuit. For example, a grid can be scaled to generate a scaled grid (e.g., a 3× scaled grid). The scaled grid can contain scaled cells (e.g., 9 scaled cells corresponding to each cell of the grid, for a two-dimensional grid). One or more cells may be defined as an index cell for the scaled cell. For example, if a scaled cell is bounded by a polygon, a single write to the index cell may indicate the entire scaled cell is bounded. The index cell can include a further flag or bit (in a same or different register) to determine the cell is an index cell. For example, a value of “00” may refer to a set index cell, a value of “01” may refer to a cleared index cell, a value of “10” may refer to a set non-index cell, and a value of “11” may refer to a cleared non-index cell. One skilled in the art will understand the illustrative examples provided herein are not intended to be limiting and that various implementations of index cells may be used in combination with the present disclosure.

By comparing scaled cells prior to additional cells, many less checks may be used (e.g., for a 3:1 scaling, a reduction of up to 9× may be achieved). A subsequent operation may determine the occupancy for further cells at a more granular resolution. Such a process may be iterated (e.g., a first pass can be conducted at 10× resolution, a second pass at 3× resolution, and a third pass at 1× resolution).

For shapes which are manufactured by cutting operations such as die saws, computerized numerical control (CNC) machining, or laser cutting, a Minkowski sum of the parts to be cut may be used to determine the first and second shape. For example, a circle having a diameter of one-half the cutting distance can be summed with the desired shapes, such that the first and second shapes are abutted a cutting distance apart from one another.

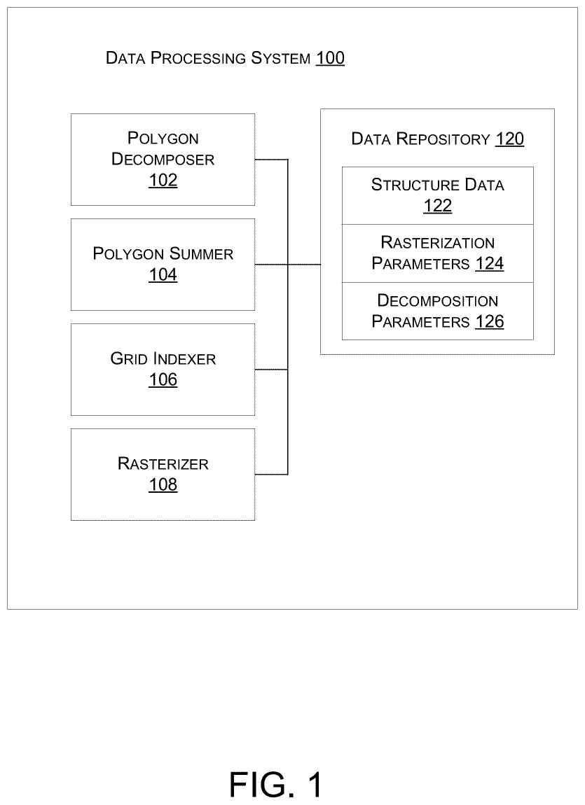

With reference to FIG. 1, an example computing environment for polygon data processing is provided, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The data processing system 100 can process structures to determine derivative information thereof, such as to determine a Minkowski sum of structures, each structure comprising constituent polygons.

In brief overview, the data processing system 100 can include one or more polygon decomposers 102. The polygon decomposer 102 can determine one or more polygons that form or approximate a received structure (e.g., the polygon decomposer 102 can determine an octagon and a rectangle corresponding to a stop sign). The data processing system 100 can include one or more polygon summers 104. The polygon summer 104 can determine combinations of polygons, such as by execution of a vertex sweep function 206 (e.g., for a Minkowski sum). The data processing system 100 can include one or more grid indexers 106. The grid indexer 106 can identify an occupancy of a cell of the grid maintained by a rasterizer 108. The data processing system 100 can include one or more rasterizers 108. The rasterizer 108 can maintain an n-dimensional grid including various cells, and a state for each of the cells.

The polygon decomposer 102, polygon summer 104, grid indexer 106, or rasterizer 108 can each include or be implemented by at least one processing unit or other logic device such as a programmable logic array engine, or module configured to communicate with a data repository 120 or database. The polygon decomposer 102, polygon summer 104, grid indexer 106, or rasterizer 108 can be separate components, a single component, or part of the data processing system 100. The data processing system 100 can include hardware elements, such as one or more processors, logic devices, or circuits. For example, the data processing system 100 can include various instances of components thereof, which may be employed to instantiate parallel instructions to process various polygons of one or more structures.

The data repository 120 can include one or more local or distributed databases, and can include a database management system. The data repository 120 can include computer data storage or memory and can store one or more data structures, such as a structure data 122, rasterization parameters 124, or decomposition parameters 126. The structure data 122 can include representations of structures received which may relate to two-dimensional (e.g., a die cut pattern), three-dimensional, or n-dimensional structures. The structures can include representations of real-word objects, simulated environments such as video games or virtual reality experiences, computer vision systems, or arbitrary data spaces. The structure data 122 can include a boundary or characteristic associated with the structure or a source thereof (e.g. a dimension of a sheet of steel such as a width or thickness). The structure data 122 can include information associated with a spacing between structures, such as a cutting width for a laser or router bit, or a keep-away distance for video graphics or other data, such as in computer vision systems.

The rasterization parameters 124 can include settings or parameters that affect the process of rasterizing or converting a structure or polygons derived therefrom onto a grid. For example, the rasterization parameters 124 can include a resolution of the grid, number of dimensions of the grid, a scaling of a grid, or a number of recursions associated with the scaling. The rasterization parameters 124 can include information associated with determining occupancy of a cell of the grid. For example, the information can determine that a cell occupancy is based on any part of an item being included within the cell, disposed along an edge of the grid, occupying an entirety of a cell, or occupying a majority of a cell.

The decomposition parameters 126 can include parameters for determining constituent shapes from structures. For example, a given decomposition parameter 126 can specify a degree of accuracy for a decomposing (e.g., when decomposing structures results in an estimation of a structure, such as with regard to curved surfaces decomposed to polygons). The decomposition parameters 126 can indicate a type of a shape to generate from a structure. For example, a given decomposition parameter 126 can include an indication to generate types of shapes such as convex shapes, triangles, etc. A decomposition parameter 126 can include a particular algorithm, weighting, boundary preservation, or memory usage. In some implementations, one or more of the decomposition parameters 126 can be integral to the polygon decomposer 102 (e.g., hardcoded or hardware implemented).

Referring further to FIG. 1, the polygon decomposer 102 can decompose a polygon to generate polygons which can be processed according to parallel operations. The parallel operations can outperform serial operations, according to an availability of compute resources. The polygon decomposer 102 can identify polygons from a structure. The polygon decomposer 102 can identify the polygons based on the decomposition parameters 126. The polygon decomposer 102 can apply one or more operations to the structure to identify the polygon(s), the one or more operations including for example and without limitation, Delaunay triangulation, Seidel's algorithm, greedy triangulation, ear clipping, or convex decomposition. The polygon decomposer 102 can determine or select one or more of the operations to apply to the structure according to a property of the structure. For example, the polygon decomposer 102 can employ Delaunay triangulation for structures which do not include holes or openings, and Seidel's algorithm for structures which include such features. According to various implementations, the polygons deconstructed from a structure may or may not overlap.

The polygon decomposer 102 can adjust operation based on available resources, or a complexity of an object (e.g., to an amount of available compute or memory). The polygon decomposer 102 can adjust a parameter of an operation, such as a selected decomposition parameter 126 according to which the polygon decomposer 102 performs decomposition or an operation of decomposition, based on a number (or other parameter indicative of resource availability) of polygon summers 104. For example, the polygon decomposer 102 can generate additional polygons corresponding to a number or total, or available instances of polygon summers 104.

For a source structure ‘A,’ the polygon decomposer 102 can generate polygons A₁, A₂ . . . A_{N}. For a source structure ‘B,’ the polygon decomposer 102 can generate polygons B₁, B₂ . . . B_{N}. Such nomenclature may be referred to henceforth, merely for ease of presentation, and is not intended to be limiting. The polygon decomposer 102 can provide an index, name, storage location, data stream, or other indication of a source structure associated with a polygon, and can include any number of structures (e.g., ‘C,’ ‘D’ and so on).

The polygon summer 104 can determine a combination or sum of a plurality of polygons. According to various implementations, the polygon summer 104 can determine a convolutional sum, Cartesian sum, overlay sum, or Minkowski sum. For example, to generate a Minkowski sum, the polygon summer 104 can retrieve the vertices of the various polygons. The polygon summer 104 can receive the polygons from the polygon decomposer 102. The received polygons can be received along with an indication of a source thereof, such as a source structure or an origin thereof. For example, the polygon summer 104 can receive polygons along with a source indication referring to a first or second structure, or further structures (e.g., for a Minkowski sum of three or more structures).

The various polygons may be or be stored or received as a combination of triangles along with an indication of a source structure. The various polygons may be stored as or received as a native representation (e.g., of rectangles, pentagons, or various polyhedrons). The polygon summer 104 can receive vertices corresponding to triangles or other polygons, such as from a vertex buffer object, index buffer object, or other data structure (e.g., triangle list, mesh data structure, etc.).

In some implementations, the polygon summer 104 can determine vertices of a polygon based on a combination of other shapes such as triangles. For example, for a pair of triangles forming a square, the polygon summer 104 can omit one of the duplicate vertices corresponding to the shared hypotenuse of the triangles. In various implementations, the polygon summer 104 can determine further vertices (e.g., an intersection of two-portions of a polygon), or discard a vertex (e.g., a vertex disposed on an interior of a larger shape, such as a point of a triangle at a center of a hexagon).

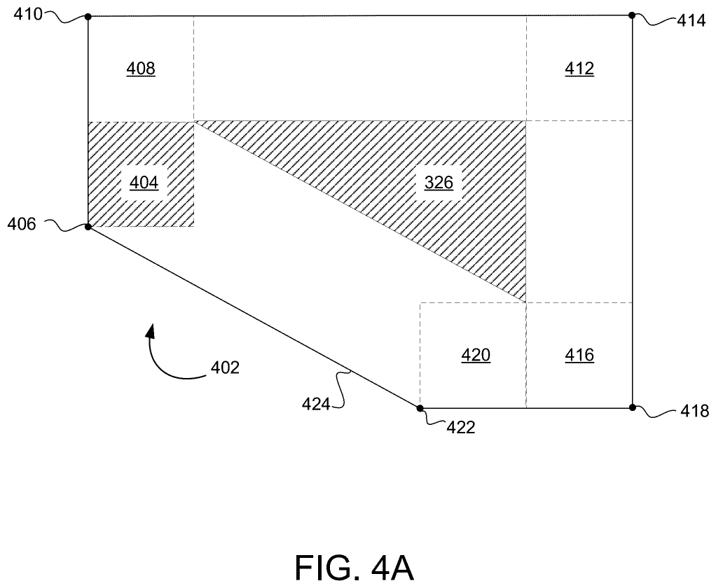

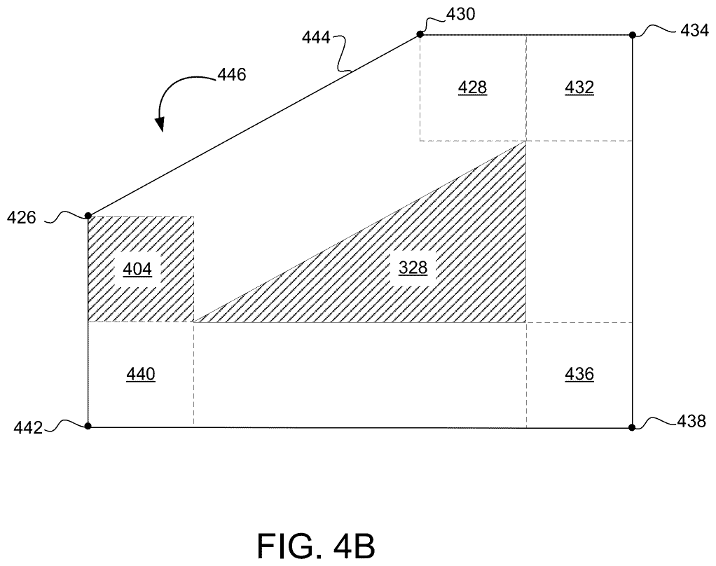

The polygon summer 104 can select corresponding pairs of received polygons, from the respective structures. For example, for structures A and B having 50 polygons each, the polygon summer 104 can select each of 2,500 (50×50) combinations of polygons. The combinations of polygons may be referred to as, for example, A₁B₁, A₁B₂ . . . A₁B_{N} . . . A_{N}B_{N}, each of which may be referred to as combined polygons, or “combinations,” to refer to the two or more source polygons or the summation thereof. The data processing system 100 can schedule each combination to an instance of a polygon summer 104 (e.g., can schedule the 2,500 combinations to a same instance, or one combination to each of 2,500 separate instances). At each instance, the polygon summer 104 can iterate through each vertex of each polygon to create a new vertex for each pair. The sum of the corresponding coordinates of the two vertices determines the position of the new vertex. Each vertex a can be defined with regard to a same origin; the vertices of the combination polygons can be defined with regard to the same origin, such that coherency is maintained between the structures and their constituent polygons. The polygon summer 104 can perform this process for all pairs of vertices, resulting in a set of new vertices that collectively form the Minkowski sum polygon, as depicted with regard to FIGS. 4A and 4B.

The polygon summer 104 can be configured to sum convex polygons such as triangles. For example, the polygon summer 104 can utilize techniques such as a convex hull computation, which helps in eliminating unnecessary vertices and reducing the complexity of the resulting polygon. The polygon summer 104 can receive polygons of limited complexity (e.g., convex polygons, regular polygons, or triangles) which may obviate the application of various techniques, wherein, for example, every triangle can be presumed convex such that concave detection can be obviated.

The grid indexer 106 can identify an occupancy of a cell of a grid maintained by the rasterizer 108. In various implementations, the grid indexer 106 can be integral to the rasterizer 108 or to the various instances of the polygon summer 104. For example, the polygon summer 104 can sum polygons to generate a combination polygon, determine an occupancy of one or more cells of the combination polygon via the integral grid indexer 106, and provide the indications to the rasterizer 108.

The grid indexer 106 can determine that a cell is occupied based at least on the cell being bounded by the combination polygon, that a majority of the cell is bounded by the polygon, that any portion of the combination polygon and the cell intersect, or that an edge of the cell is shared with an edge of a combination polygon. For example, the grid indexer 106 can determine multiple occupancies corresponding to multiple occupancy types (e.g., as stored by separate bits or flags of an occupancy register), or can determine an occupancy based on a configuration or setting, such as a rasterization parameter 124.

The grid indexer 106 can detect one or more intersections between at least one polygon (or a portion thereof) and at least one cell according to one or more algorithms or operations, including, for example and without limitation, a scan line algorithm, bounding shapes (e.g., bounding boxes or bounding polygons), ray casting or other light transport simulation techniques, sweep line algorithms, line segment intersection algorithms. For example, the grid indexer 106 can employ at least one scan line per cell row, cell column, or other cell dimension (e.g., Z-axis). In some implementations, the grid indexer 106 can employ a scan line for each edge of a cell. The grid indexer 106 can maintain an active edge list containing edges intersected by the current scanline to determine whether the combination polygon is inside or outside the shape. For a convex polygon (e.g., a triangle), the edge list may be composed of an entering and exiting edge for a scan line. For a two-dimensional cell, the scan line can include a top scan line, bottom scan line, left scan line, and right scan line. The intersection of one or more scan lines with the combination polygon can be indicative of an overlap; an intersection of each cell vertex with a combination polygon can be indicative of a bounded (e.g., entirely occupied) cell.

The rasterizer 108 can maintain a grid including various cells, and a state for each of the cells. For example, the cells can correspond to a two-dimensional grid, wherein the cells may be referred to as pixels, a three-dimensional grid, wherein the cells may be referred to as voxels, or so forth. The rasterizer 108 can be in communication with one or more instances of the grid indexers 106, and receive indications of occupied cells therefrom.

The rasterizer 108 can receive an indication of cell occupancy, from the grid indexer 106, for a combination of each of the instances of the polygon summer 104. For example, for a cell which is occupied by 50 combinations, the rasterizer 108 can receive an indication corresponding to any or each of the 50 combinations.

The rasterizer 108 can provide a current occupancy status of a cell. For example, the rasterizer 108 can identify one or more instances of a register, cache, or other memory location with respect to any of various sets of grid indexers 106. The grid indexers 106 can verify a current condition of a register prior to writing to that location, to decrease a total number of writes received by the rasterizer 108, and a contention of an associated bus, memory location, etc. The grid indexer 106 can access the rasterizer 108 in a read-write-modify operation. The rasterizer 108 can maintain memory location coherency according to a logical “OR” of the various memory locations.

The rasterizer 108 can omit a storage of a combination polygon or portion which indicated an occupancy of a cell. For example, the rasterizer 108 can store a binary indication or “occupied” or “not occupied” without an indication of a number of occupying combination polygons or an identity of the occupying polygons. In some implementations, responsive to detecting that an indication is assigned to a given cell (e.g., by performing a read operation on the given cell to retrieve the indication), the rasterizer 108 can skip performing a write operation or other operation(s) for determining whether the given cell is occupied.

In some implementations, the rasterizer 108 can store further information corresponding to a cell, such as an indication of total or partial occupation, or whether the occupying cell was an edge cell of a combination polygon. The rasterizer 108 or other components of the data processing system 100 can employ such information to reduce a number of operations or writes. Such further information may omit an identity or number of combination polygons occupying the cell. For example, responsive to the rasterizer 108 detecting that a first combination polygon partially occupies a cell, the rasterizer 108 can perform a subsequent write to indicate that the cell is fully occupied; responsive to detecting that the first combination polygon fully occupies the cell a subsequent indication of partial occupation can be omitted or disregarded.

The rasterizer 108 can arbitrate access to receive an occupancy of a cell. For example, the rasterizer 108 can implement a round robin, dynamic load balancing, or another arbitration technique. The rasterizer 108 can arbitrate access to the entire rasterizer 108, or to a portion thereof. For example, the rasterizer 108 can arbitrate access on bit, byte, word, page, segment, or other memory portion. The rasterizer 108 can include multiple instances of memory location which can be accessed by various grid indexers 106 in case of contention. Such memory locations can be logically or physically OR′d to store the state of the occupancy of the cell.

The rasterizer 108 can include a scale factor such as an integer scale factor. For example, a grid can have a native resolution of 1024×1024 pixels, and a 2× scaled grid of 512×512 pixels, a 4× scaled grid of 256×256 pixels, and so forth can be rasterized. The rasterizer 108 can indicate a separate data location or index cell to store information corresponding to a scaled cell. For example, the index cell can include an indication of a scaling or a value, and in indication of whether a scaled cell is occupied.

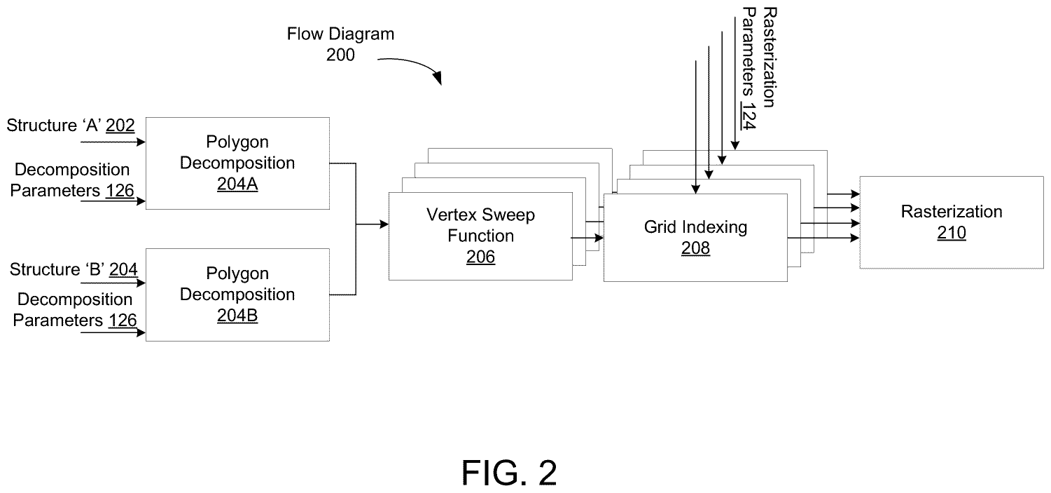

FIG. 2 is a flow diagram 200 of an example of a data flow to determine a summation from two structures. The structures are depicted as Structure ‘A’ 202 and Structure ‘B’ 204. The structures can include various features, such as curved or concave surfaces and voids. In some implementations, additional structures can be received. In some implementations, a cascade of the depicted data flow can be employed. For example, in a first stage, each of Structure ‘A’ 202 and Structure ‘B’ 204 can be separately received along with a sphere having a diameter equal to half a cutting distance of a laser or router bit to form respective sums of Structure ‘A′’ and Structure ‘B′’. A combination of Structure ‘A′’ and Structure ‘B′’ can define a no-fit polygon for Structure ‘A’ 202 and Structure ‘B’ 204 along with an allowance for cutting between the two.

Returning to the depicted flow diagram 200, a polygon decomposer 102 can receive structure ‘A’ 202 along with decomposition parameters 126 to decompose the structure to perform a first instance of polygon decomposition 204A based thereupon. The first instance of polygon decomposition 204A can generate various constituent polygons of structure ‘A’ 202, each of which is conveyed to (e.g., scheduled or queued for) a polygon summer 104 to perform a vertex sweep function 206. In some implementations, a memory store can store the polygons generated from the first instance of polygon decomposition 204A.

A same or different polygon decomposer 102 can receive structure ‘B’ 204, along with decomposition parameters 126 which may be the same decomposition parameters 126 received incident to the first instance of polygon decomposition 204A, can vary therefrom. The second instance of polygon decomposition 204B can generate various constituent polygons of structure ‘B’ 204 which are conveyed to a polygon summer 104. In some implementations, a memory store can store the polygons generated from the second instance of polygon decomposition 204B.

Each of a plurality of polygon summers 104 can receive a constituent polygon from each of structure ‘A’ 202 and structure ‘B’ 204. For example, every combination between such constituent polygons can be scheduled queued for a polygon summer 104, whereupon the polygon summer 104 can execute a vertex sweep function 206, as described by reference of, for example, FIGS. 4A and 4B. The execution of the vertex sweep function 206 can generate a combination polygon, such as a Minkowski sum combination polygon.

Each polygon summer 104 can include or be communicatively coupled with a grid indexer 106. The polygon summer 104 can provide a representation (e.g., a set of vectors) of the combination polygon to the grid indexer 106. The grid indexer 106 can perform grid indexing 208 using the representation to determine an occupancy of various cells according to the combination polygons and rasterization parameters 124 (which may be integral to the grid indexer 106 or received by the grid indexer 106 from a data repository 120). The polygon summer 104 can convey the determination of occupancy to the rasterizer 108 for rasterization 210 the polygon. In some implementations, such a conveyance can include a detection of an existing occupancy (e.g., to reduce write accesses to the rasterizer 108). In some implementations, such a conveyance can omit a detection of an existing occupancy (e.g., to reduce compute of the grid indexer 106). Upon a completion of the rasterization 210 of each combination polygon, the rasterizer can output a data structure indicative of the occupied cells of a grid thereof. Such a grid may depict a no-fit polygon for structure ‘A’ 202 and structure ‘B’ 204.

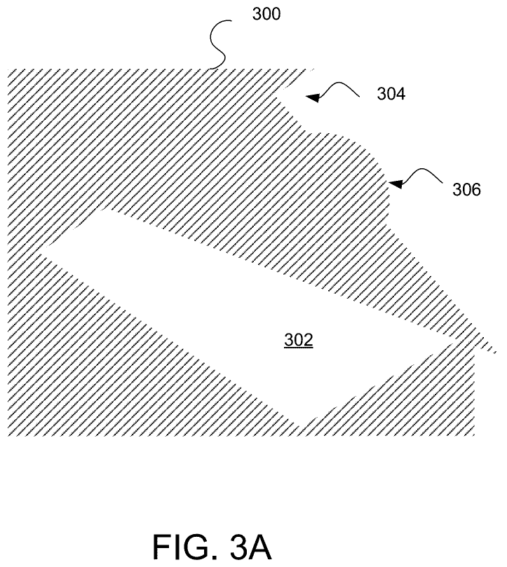

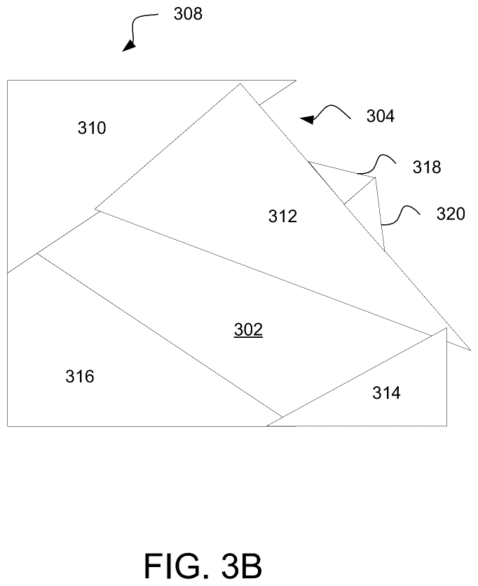

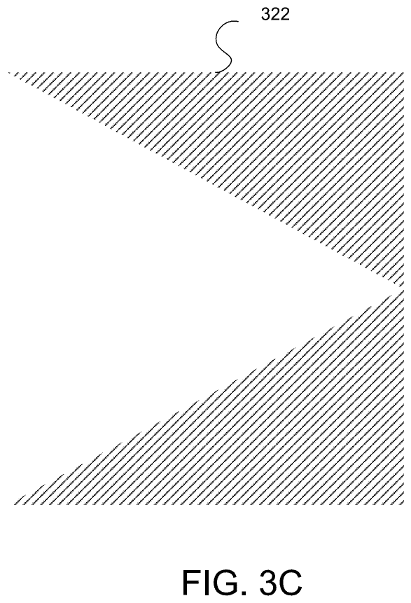

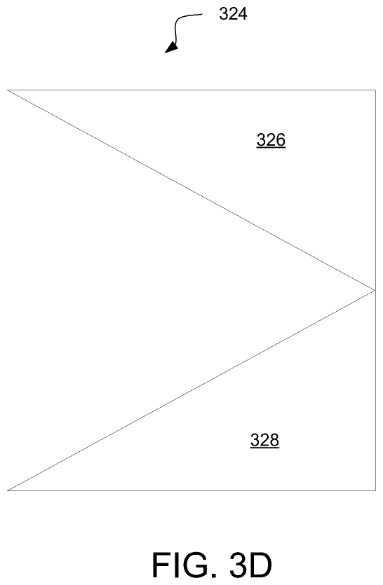

FIGS. 3A, 3B, 3C, and 3D are diagrams illustrating an identification of various polygons corresponding to structures. FIG. 3A depicts a structure 300 including a void 302, a concave surface 304, and a curved surface 306. It is noted that various structures 300 can include these or other features which may be incompatible or challenging to generate sums, such as Minkowski sums, according to various techniques. A decomposition of the structure can identify various polygons which can represent the structure 300.

Referring now to FIG. 3B, a set 308 of polygons corresponding to the structure 300 is identified. The set 308 includes a same concave surface 304 which is shown based on an intersection of two of the set 308 of polygons, such that no individual polygon is concave. A void 302 corresponds to the void 302 of the structure 300. The void 302 is surrounded by a first polygon 310, second polygon 312, and third polygon 314, and fourth polygon 316. As depicted, various of the set 308 of polygons can include overlaps therebetween, such as along a boundary of the fourth polygon 316 with each of the first polygon 310 and third polygon 314. The curved surface of FIG. 3A is shown represented by a fifth 318 and sixth 320 identified polygon. According to decomposition parameters 126, additional or fewer polygons may be identified to approximate the curved surface 306 or other features of the structure 300.

Referring now to FIG. 3C, a second structure 322 is provided. As shown, with regard to FIG. 3D, a second set 324 or polygons including a first triangle 326 and second triangle 328 are identified based on the second structure 322. In various implementations, additional or different polygons may be identified according to a structure 300 and decomposition parameters 126. Hereinafter, a summation will be determined with regard to a non-limiting selection of the first triangle 326 and second triangle 328, selected for ease of depiction and brevity.

FIG. 4A is a diagram illustrating an example 402 of a process performed by the vertex sweep function 206 for the first triangle 326. The vertex sweep function 206 can be performed with one or more polygons of a further structure (not depicted herein). For example, each of the first triangle 326 and second triangle 328 can be polygon A₁ and A₂ of the second structure 322 of FIG. 3, and the depicted square 404 can be B₁ of the further structure (not depicted herein), which can include any number (e.g., zero or more) additional polygons. In some implementations, the square 404 may be further decomposed such as to a pair of triangles, B₁, and B₂.

The polygon summer 104 can receive the square 404 and first triangle 326, and align a first vertex of each to identify a first combination vertex 406. Thereafter, the polygon summer 104 can transpose the square 404 (e.g., clockwise, as depicted) to a second position 408 to define a second combination vertex 410; a third position 412 to define a third combination vertex 414; a fourth position 416 to define a fourth combination vertex 418; and a fifth position 420 to define a fifth combination vertex 422. The combination vertices 406, 410, 414, 418, 422 can define a first combination polygon 424 for the square 404 and the first triangle 326.

Referring now to FIG. 4B, an example 446 of a summation of the square 404 and the second triangle 328 is generated. For example, the polygon summer 104 can align a vertex of each to identify a sixth combination vertex 426. Thereafter, the polygon summer 104 can transpose the square 404 to a seventh position 428 to define a seventh combination vertex 430; an eighth position 432 to define an eighth combination vertex 434; a ninth position 436 to define a ninth combination vertex 438; and a tenth position 440 to define a tenth combination vertex 442. The combination vertices 426, 430, 434, 438, 442 defined by the depicted vertex sweep function 206 can define a second combination polygon 444 for the square 404 and second triangle 328.

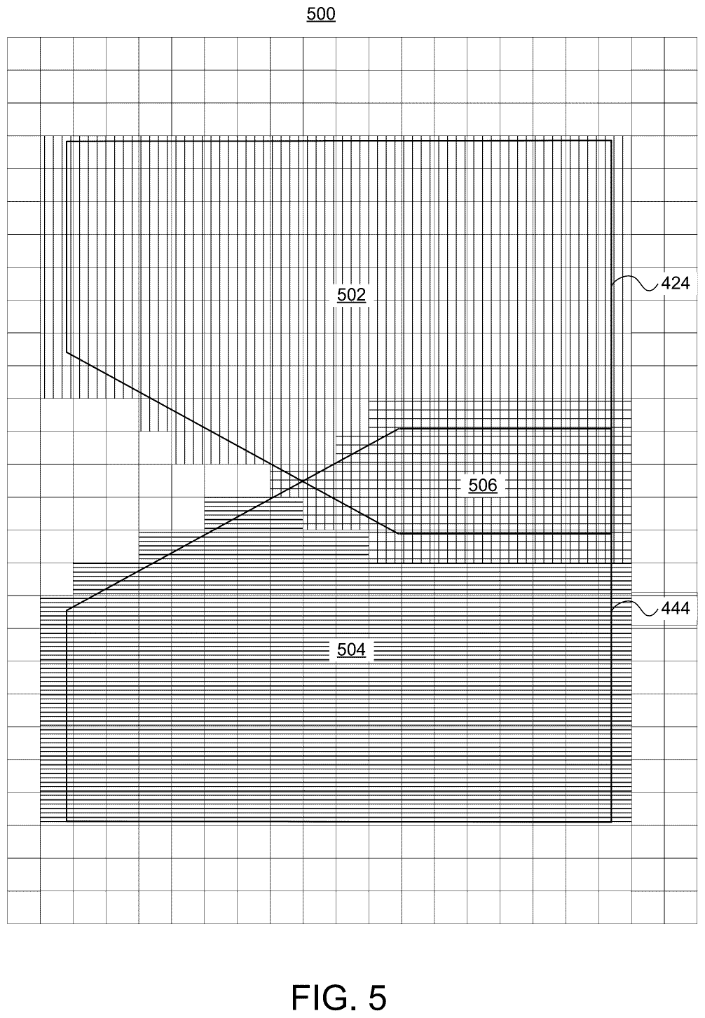

FIG. 5 depicts an example of rasterization 210 of a shape summation over a grid 500. Each of the first combination polygon 424 and the second combination polygon 444 are disposed over the grid 500 relative to a shared origin (e.g., an origin associated with the second structure 322 of FIG. 3 and the square 404 of FIG. 4). As depicted, a first set of cells 502 of the grid 500 are indicated as occupied by the first combination polygon 424. A second set of cells 504 of the grid 500 are indicated as occupied by the second combination polygon 444. A third set of cells 504 of the grid 500 are indicated as occupied by both of first combination polygon 424 and the second combination polygon 444.

In some implementations, the rasterizer 108 may not discriminate between the first set of cells 502, the second set of cells 504, and the third set of cells 506. For example, the rasterizer 108 may maintain a register, flag, or other data structure to indicate of occupancy of each cell. Each of the first set of cells 502, the second set of cells 504, and the third set of cells 506 can indicate a same occupancy. In some implementations, the register, flag, or other data structure can indicate an occupancy type such for whole or partial occupation.

In some implementations, a polygon summer 104 associated with the first combination polygon 424 can provide an indication of occupancy to the rasterizer 108 for each of the cells occupied by the first combination polygon 424 (e.g., the first set of cells 502 along with the third set of cells 506). Likewise, a polygon summer 104 associated with the second combination polygon 444 can provide an indication of occupancy to the rasterizer 108 for each of the cells occupied by the second combination polygon 444 (e.g., the second set of cells 504 along with the third set of cells 506). Thus, an indication of occupancy for the third set of cells 506 is set (to a same value) twice. In some implementations, the first combination polygon 424 is rasterized prior to the second combination polygon 444. For example, a polygon summer 104 associated with the first combination polygon 424 can provide an indication of the occupancy of the first set of cells 502 along with the third set of cells 506 prior to an indication received from the polygon summer 104 associated with the second combination polygon 444. The polygon summer 104 can thereafter receive an indication of occupancy of the second set of cells 504 and the third set of cells and 506, determine that the first set of cells are already occupied, and provide an indication of the occupancy of the third set of cells 506 without an explicit indication of occupancy of the second set of cells 504.

The depicted grid 500 is provided as an illustrative example. In some embodiments, the data processing system 100 can perform rasterization 210 according to further techniques. For example, rasterization 210 can be performed separately for each convex polygon, (e.g., combination polygons 424 and 444). For example, in some embodiments, the data processing system 100 determine vertices with highest and lowest values along an axis (e.g., extremes of an X or Y axis, in a two-dimensional space as is depicted in FIG. 5). The highest and lowest values can define a centerline disposed therebetween, as may be parallel to the X or Y axis. A terminus of each edge of the convex polygon is connected to opposite ends of the centerline, to define a four-sided polygon. In some instance, the four-sided polygon can include one side length of zero, corresponding to a centerline terminus coinciding with an edge terminus. The data processing system 100 can thereafter determine any pixels inside (e.g., bounded by or included in) the four-sided polygon and identify the pixels (e.g., set an occupancy flag) corresponding to the pixel. The rasterization 210 may be repeated for each combination polygons of various structures such that the various identified pixels can, in aggregate, determine occupancy of the pixels. For example, a particular pixel can be indicated as occupied according to multiple of the repeated rasterizations, as to effect a union operation between the occupied pixels of the various combination polygons.

In some implementations, the grid may be a displayed grid 500. However, in some implementations, the rasterization 210 of the shape summation may be a data structure which is not presented graphically, such that a graphical depiction is only provided for a final output of all shapes, or no graphical depiction is provided a plurality of regular subdivisions (e.g., cells) of such a data structure may further be referred to as a grid 500. For example, in various implementations, the systems and methods herein are employed to determine a presence of a collision, or a violation of a keep away zone, whereupon a Boolean indication of such a collision or violation is provided without graphical depiction.

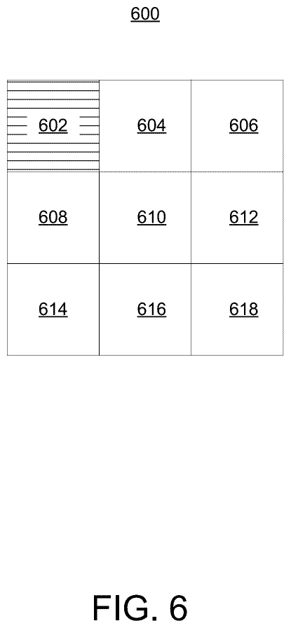

FIG. 6 depicts an example of a scaled cell 600 of a grid. Various implementations of the present disclosure can include various scalings, such as various instances of integer (e.g., 1:2, 1:3, 1:4, etc.) or non-integer (e.g., 3:2) scalings. Advantageously, integer scaling may reduce operations to determine the state of various scaled cells 600 from non-scaled cells or non-scaled cells from scaled cells 600. The depicted scaled cell 600 include an index cell 602 to indicate a state of the scaled cell 600. Although depicted graphically for illustrative purposes, the index cell 602 may correspond to one or more bit flags, register locations, memory structure portions, or the like. The index cell 602 can include an indication of the scaling of a grid 500, or can lack such an indication. For example, a global indicator separate from an index cell 602 can indicate a scaling for a grid 500.

The index cell 602 can include an indication of a state of the various cells of the scaled cell 600. For example, the index cell 602 can indicate an occupancy of a second cell 604, third cell 606, fourth cell 608, fifth cell 610, sixth cell 612, seventh cell 614, eighth cell 616, and ninth cell 618 of the scaled cell 600 (which, along with the index cell 602, can be referred to as constituent cells of the scaled cell 600). The indication of the index cell 602 can include one or more indications of occupancy. For example, the determination of occupancy can be based on a partial, complete, majority, or other indication of occupancy for each cell, or further be based on various combinations of cells. For example, the determination of occupancy can be determined according to a logical OR, or a logical AND of each cell. For example, to determine the scaled cell 600 is fully occupied, the grid indexer 106 can indicate an execution of a logical AND of the constituent cells thereof; to determine the scaled cell 600 is partially occupied, the grid indexer 106 can indicate an execution of a logical OR of the constituent cells thereof. In various implementations, the occupancy of a cell can be determined natively. For example, the grid indexer 106 can natively determine an occupancy of a combination polygon with respect to a scaled cell 600.

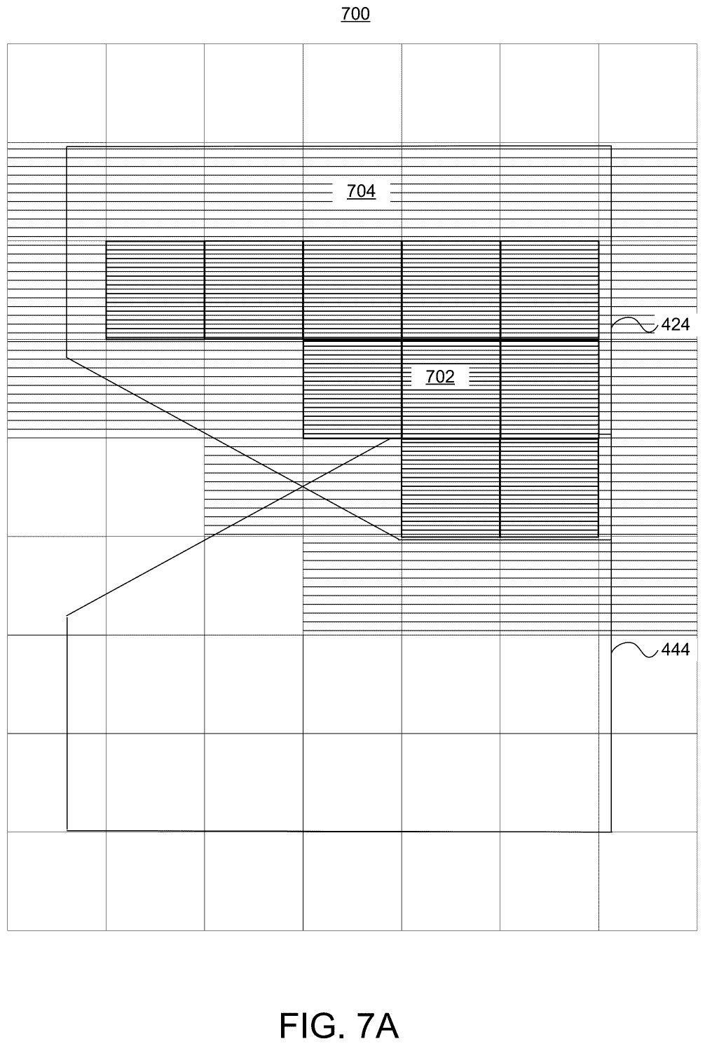

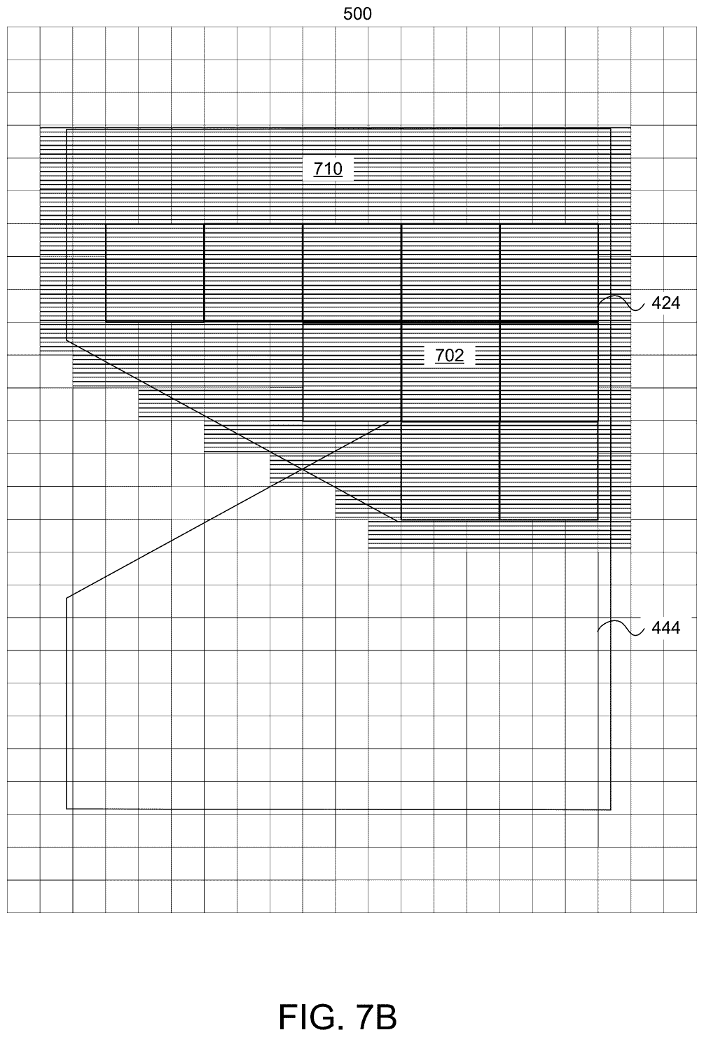

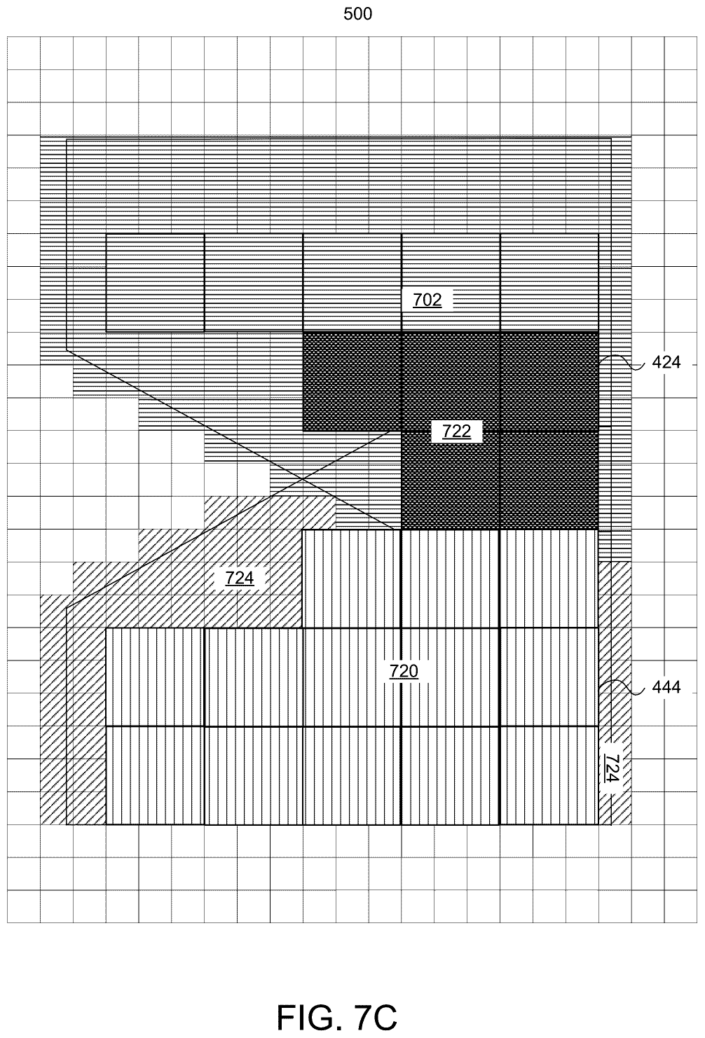

FIGS. 7A, 7B, and 7C depict an example of multi-level recursive rasterization 210 of the shape summation of FIG. 5. In some implementations, it can be useful for the data processing system 100 to perform multiple levels of operations of identifying occupied regions of the space corresponding to the shape summation. For example, the data processing system 100 (e.g., components of the data processing system 100 such as grid indexer 106 and/or rasterizer 108, etc.) can perform a first pass of identifying cells occupied in a relatively coarse grid (e.g., a grid having cells of relatively larger dimensions), and, responsive to identifying the cells of the first pass, perform one or more second passes of identifying cells occupied in one or more relatively fine grids (e.g., a grid having cells of relatively smaller dimensions), such as to selectively evaluate cells outside of the region(s) of cells identified in the first pass to identifying in the subsequent second pass(es). The data processing system 100 can perform various such operations in an iterative and/or recursive manner. As described further herein, performing such operations can allow the data processing system 100 to reduce overall computational resource usage for identifying occupied regions of the space and/or increase the precision of identifying occupied regions, such as by taking advantage of the fact that the first pass(es) that are performed can detect significant portions of occupied space and the subsequent second pass(es) can precisely complete the detections around boundaries/edges of the detections from the first pass(es).

Referring to FIG. 7A, a scaled grid 700 is depicted, corresponding to a 3:1 scaling of the grid 500 of FIG. 5. The first combination polygon 424 and the second combination polygon 444 are shown disposed on the scaled grid 700. A memory usage and compute associated with determining an occupancy of the scaled grid 700 can be less than a corresponding memory usage or compute of determining the occupancy of the grid 500 of FIG. 5. The grid indexer 106 can identify a first set of scaled cells 702 as bounded by the first combination polygon 424. However, the scaled cells indicate a lower resolution, and thus may depict a lower accuracy of the bounds of various combination polygons.

In some implementations, the grid indexer 106 can identify a second set of scaled cells 704 as partially occupied by the first combination polygon 424. The constituent cells of the second set of scaled cells 704 can thereafter be processed, by the grid indexer 106, to determine an occupancy thereof.

Referring now to FIG. 7B, the grid 500 of FIG. 5 is depicted along with the first set of scaled cells 702 of FIG. 7A. Depiction of the determination of the occupancy of the set of non-scaled cells 710 is illustrated. Such occupancy can be identified by the grid indexer 106. As depicted, the occupancy of the set of non-scaled cells 710, along with the first set of scaled cells 702 can determine a same occupancy relative to the determinations depicted on the grid 500 of FIG. 5. However, a lesser number of total cells and thus total writes, data transfers, or other operations can be performed.

Referring now to FIG. 7C, the rasterizer 108 can rasterize the second combination polygon 444. The sequence of rasterization 210 may vary according to polygon complexity, bus access times and other system performance attributes, a sequencing or assignment of various polygons or combination polygons, or the like. For example, separate polygon summers 104 operating in parallel can access the rasterizer 108 to provide an indication for an occupancy of various cells or scaled cells prior to, subsequent to, or interleaved with the other of the polygon summers 104. Merely for clarity, the second combination polygon 444 will be described as being rasterized subsequent to the first combination polygon 424. It is noted that rasterizations 210 may be perfumed in various sequences, be interleaved, or simultaneous, wherein the rasterizer 108 can arbitrate to resolve any contention.

A third set of scaled cells 720 of the second polygon 444 are identified. Of the third set of scaled cells 720 a first portion 722 can also be included in the first set of scaled cells 702. For example, the first portion 722 can include scaled cells which are completely bounded by the second combination polygon 444, and which are partially bounded by the second combination polygon 444. In various implementations, the grid indexer 106 or rasterizer 108 can determine that the cells are indicated as occupied cells, even where the data processing system 100 is determining fully bounded scaled cells, since the cells are fully bounded by the first combination polygon 424. In various implementations, the grid indexer 106 or rasterizer 108 can disregard the partially occupied scaled cell (e.g., because they are already indicated as occupied by the first combination polygon 424). In various implementations, the grid indexer 106 or rasterizer 108 can determine an occupancy of unscaled cells which is logically OR′d with the occupancy from the first combination polygon 424 (e.g., by writing to a same location twice). In some implementations, the grid indexer 106 or rasterizer 108 can access the non-scaled cell, receive an indication that the non-scaled cell is a constituent cell of a scaled cell, and is already occupied (e.g., a read or write for a non-scaled cell can return a result for the scaled cell). In some implementations, the grid indexer 106 or rasterizer 108 may not access the non-scaled cell (e.g., because the cell is already included in a scaled cell). In some implementations, write accesses to a register of a cell which is a constitute cell can be masked or otherwise prevented, with or without an indication to the writer.

Further depicted in FIG. 7C are scaled and non-scaled cells sharing a boundary of with a polygon along the lower surface of the second polygon 444. In various implementations, such cells may be identified as bounded or partially occupied. In various implementations, a further cell may be determined as occupied based on the zero-distance (e.g., the cells disposed immediately below the second polygon 444 can be identified on partially occupied based on the shared edge with the second polygon 444).

A peripheral set of cells 724 is identified along the partially occupied cells of FIG. 7C, is depicted. The peripheral set of cells 724 are shown as non-contiguous. In various implementations, such cells can be contiguous or non-contiguous. The peripheral nomenclature is provided in reference to the depicted implementation and should not be construed as limiting. For example, in some implementations, (e.g., implementations which include voids), a set of such cells 724 can include cells disposed along an interior portion of a structure.

As further polygons are mapped to the grid 500/700, the identification of the scaled cells 600 can further reduce computer or memory operations. For example, an edge formed from a third, fourth or fifth combination polygon with the grid 700 can include overlaps with existing identified scaled or non-scaled cells, which may obviate at least a portion of an operation, by the grid indexer 106, to determine an occupancy of a cell (e.g., a value can be retrieved from a data structure, rather than determining an intersection of a polygon with a scan line).

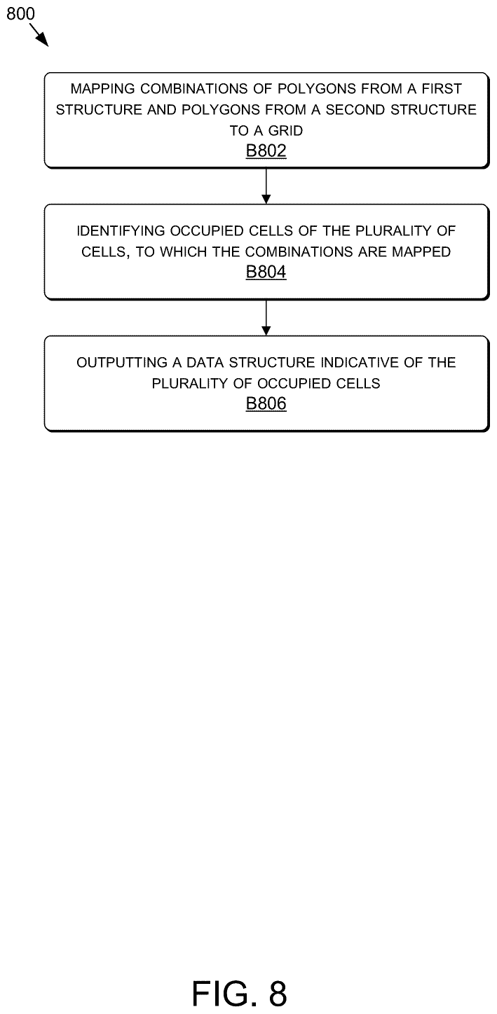

Now referring to FIG. 8, each block of the method 800, described herein, comprises a computing process that may be performed using any combination of hardware, firmware, and/or software. For instance, various functions may be carried out by a processor executing instructions stored in memory. The method 800 may also be embodied as computer-usable instructions stored on computer storage media. The method 800 may be provided by a standalone application, a service or hosted service (standalone or in combination with another hosted service), or a plug-in to another product, to name a few. In addition, the method 800 is described, by way of example, with respect to the data processing system 100 of FIG. 1. However, this method 800 may additionally or alternatively be executed by any one system, or any combination of systems, including, but not limited to, those described herein.

FIG. 8 is a flow diagram showing a method 800 for shape processing, in accordance with some implementations of the present disclosure. Various operations of the method 800 can be implemented by the same or different devices or entities at various points in time. For example, one or more first devices may implement operations relating to disaggregating polygons from structures, and one or more second devices, such as a GPU, may implement operations such as summing combinations of polygons to rasterize a grid indicative of a summation of the respective structures. Moreover, the blocks provided herein should not be construed as limiting. Additional operations may be provided, or existing operations may be omitted or substituted. For example, in some embodiments, a data processing system 100 can further decompose structures to generate the identified polygons from the structures referred to at block B802.

The method 800, at block B802, includes mapping one or more combinations of a plurality of first polygons identified from a first structure and a plurality of second polygons identified from a second structure, to a grid comprising a plurality of cells. For example, the mapping can be performed by one or more polygon summers 104 by determining a combination of the first and second polygons, such as a Minkowski sum. Each combination polygon can be defined with reference to a same origin as the first structure and the second structure, such that a combination of the combination polygons can represent a summation of the first and second structures. That is, the summation may be associative such that the summation of the various components of the structures can generate a same summation as the structures themselves. The mapping can include the generation or conveyance of vertices of the combination polygons. Such a conveyance can include a conveyance to a grid indexer 106 which may be integral to, or separate from, the polygon summer 104. Each such grid indexer 106 may correspond to one or more polygon summers 104. For example, a scheduler or queue can associate any number of polygon summers 104 with any number of grid indexers 106.

The method 800, at block B804, includes identifying one or more occupied cells of the plurality of cells, to which the one or more combinations are mapped. The occupancy can be determined by the grid indexer 106, according to one or more techniques described with regard to FIG. 1, or otherwise employed to determine cell occupancy (e.g., an intersection or overlap between a gridded pixel or voxel, and a polygon).

The occupancy can be determined according to rasterization parameters 124. For example, the rasterization parameters 124 can include an indication that, for a first iteration of a recursive process, the occupancy is determined according to a boundedness of a scaled cell 600, and that for a second iteration of the recursive process, the occupancy is determined according to any intersection between any portion of the cell with any portion of the polygon. According to various implementations, such an intersection may or may not include point or edge intersections (e.g., polygons sharing one or more points but not sharing a volume), or the rasterization parameters 124 can include separate selectable parameters for each intersection type. In some embodiment, the occupancy is determined to any of various rasterization operations, some illustrative examples of which are provided at, for example, FIG. 5.

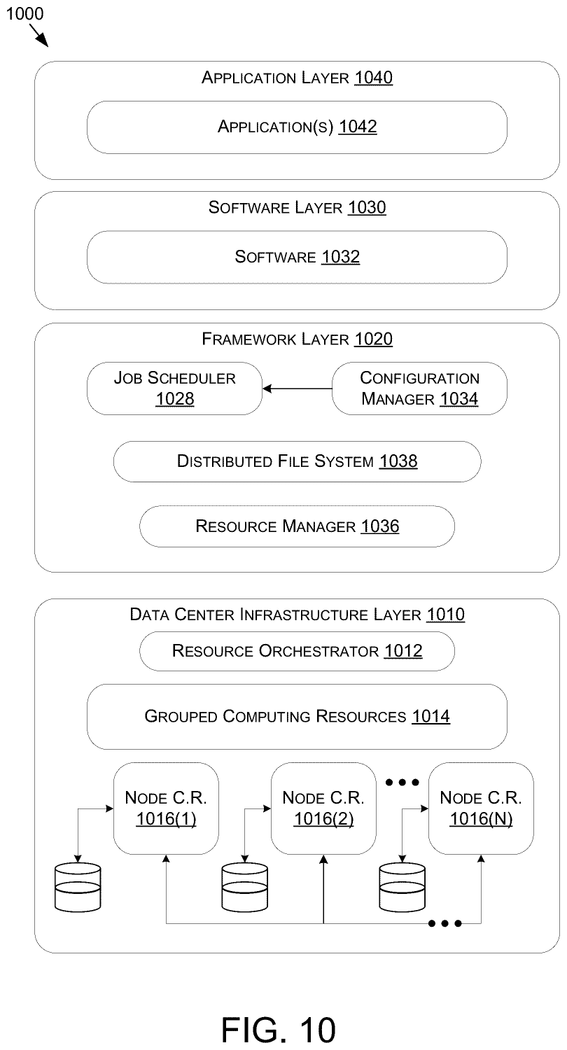

The method 800, at block B806, includes outputting a data structure indicative of the plurality of occupied cells. The output of the data structure can include output, by the rasterizer 108, to a display device such as a computer monitor, virtual reality or augmented reality device, or the like. The output of the data structure can include an output to a stamping machine, cutting tool, CNC, or other equipment configured to form the first and second structure. The output of the data structure can include an output to another module of the data processing system 100 (e.g., a module configured to determine shape placement or cutting operations to generate a structure from a predefined shape such as a sheet of steel, block of aluminum, or 3D printer). The output of the data structure can include a conveyance, over a network, including a local network (e.g., PCIe or AXI) or another network, such as the Internet, or another network as described in greater detail with reference to FIG. 10.

### Example Computing Device

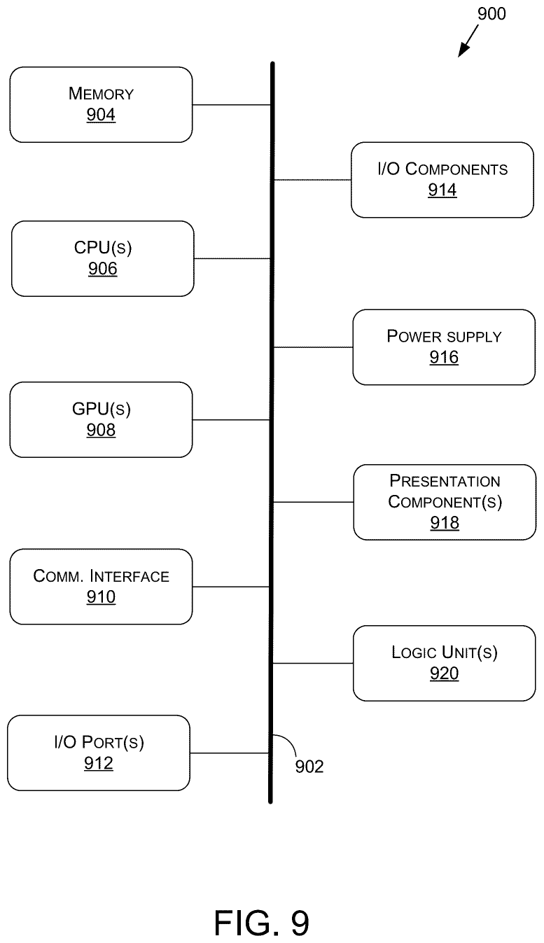

FIG. 9 is a block diagram of an example computing device(s) 900 suitable for use in implementing some implementations of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one implementation, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some implementations, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may be arranged in various topologies, including but not limited to bus, star, ring, mesh, tree, or hybrid topologies. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In some implementations, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU), such as to implement one or more operations described with reference to the system 100. The GPU(s) 908 may include hundreds or thousands of cores that are capable of handling hundreds or thousands of software threads simultaneously (e.g., corresponding to instances of the polygon summer 104). The GPU(s) 908 may generate pixel data for output images or other data structures in response to rendering (e.g., rasterization 210) commands (e.g., rendering commands from the CPU(s) 906 received via a host interface, or input from a grid indexer 106). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In implementations, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In implementations, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 920 and/or communication interface 910 may include one or more data processing units (DPUs) to transmit data received over a network and/or through interconnect system 902 directly to (e.g., a memory of) one or more GPU(s) 908. In some implementations, a plurality of computing devices 900 or components thereof, which may be similar or different to one another in various respects, can be communicatively coupled to transmit and receive data for performing various operations described herein, such as to facilitate latency reduction.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, CNC machine, laser cutting tool, machine vision system, etc. The I/O components 914 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.). The presentation component(s) 918 may include communicative connections configured to output various data structures comprising the polygon summations.

### Example Data Center

FIG. 10 illustrates an example data center 1000 that may be used in at least one implementations of the present disclosure, such as to implement the data processing system 100 in one or more examples of the data center 1000. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one implementation, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1016(1)-1016(N) may correspond to a server having one or more of the above-mentioned computing resources. In addition, in some implementations, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one implementation, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one implementation, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one implementation, resource orchestrator 1012 may include a software design infrastructure (SDI) management entity for the data center 1000. The resource orchestrator 1012 may include hardware, software, or some combination thereof.

In at least one implementation, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one implementation, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one implementation, clustered or grouped computing resources may include grouped computing resource 1014 at data center infrastructure layer 1010. The resource manager 1036 may coordinate with resource orchestrator 1012 to manage these mapped or allocated computing resources.

In at least one implementation, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one implementation, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), simulation software for rendering and updating simulated or virtual environments and/or other machine learning applications used in conjunction with one or more implementations, such as to train, configure, update, and/or execute machine learning models.

In at least one implementation, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more implementations described herein, including but not limited to for polygon decomposers 102. For example, a machine learning model(s) may be trained by calculating constituent polygons according to a neural network architecture using software and/or computing resources described above with respect to the data center 1000. In at least one implementation, trained or deployed machine learning models corresponding to one or more neural networks may be used to infer or predict information using resources described above with respect to the data center 1000 by using weight parameters calculated through one or more training techniques, such as but not limited to those described herein (e.g., decomposition parameters 126).

In at least one implementation, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. Such an interpretation should not be interpreted to limit recitations of “or” which may refer to one or more or elements of a set of elements of a set. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
map one or more combinations, of a plurality of first polygons identified from a first structure and a plurality of second polygons identified from a second structure, to a grid comprising a plurality of cells;
identify one or more occupied cells of the plurality of cells, to which the one or more combinations are mapped; and
output a data structure indicative of the plurality of occupied cells.

2. The processor of claim 1, wherein:
the grid is a first grid, the plurality of cells are a plurality of first cells, and the one or more occupied cells are one or more first occupied cells; and
the one or more circuits are to:
identify, in at least one second grid comprising a plurality of second cells, at least one region corresponding to the one or more first occupied cells, at least one second cell of the plurality of second cells smaller than at least one first cell of the plurality of first cells;
map the one or more combinations to one or more second cells of the plurality of second cells outside of the at least one region to identify one or more second occupied cells of the plurality of second cells outside of the at least one region; and
determine the data structure according to the plurality of first occupied cells and the plurality of second occupied cells.

3. The processor of claim 1, wherein the one or more circuits comprise a plurality of first circuits to determine the plurality of combinations, wherein each of the first circuits is communicatively coupled to a second circuit to set a flag of the second circuit, the flag being indicative that a given cell is one of the plurality of occupied cells.

4. The processor of claim 1, wherein each of the plurality of occupied cells is bounded by the plurality of combinations.

5. The processor of claim 1, wherein at least one first polygon is a convex polygon, and the first structure is a non-convex polygon.

6. The processor of claim 1, wherein the one or more circuits comprise a plurality of parallel computing circuits, each parallel computing circuit of the plurality of parallel computing circuits to independently determine a corresponding combination of the one or more combinations.

7. The processor of claim 1, wherein:
the grid is a three-dimensional grid; and
each cell is a voxel of the three-dimensional grid.

8. The processor of claim 1, wherein the data structure represents a no-fit polygon (NFP) for arranging a plurality of parts corresponding to the first structure and the second structure.

9. The processor of claim 1, wherein the processor is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models (LLMs);
a system implementing one or more vision language models (VLMs);
a system for performing conversational AI operations;
a system for generating synthetic data;
a system incorporating one or more virtual machines (VMs);
a system implemented at least partially in a data center; or
a system implemented at least partially using cloud computing resources.

10. A system comprising:
one or more circuits to:
map one or more combinations, of a plurality of first polygons identified from a first structure and a plurality of second polygons identified from a second structure, to a grid comprising a plurality of cells;
identify one or more occupied cells of the plurality of cells, to which the one or more combinations are mapped; and
output a data structure indicative of the plurality of occupied cells.

11. The system of claim 10, wherein:
the grid is a first grid, the plurality of cells are a plurality of first cells, and the one or more occupied cells are one or more first occupied cells; and
the one or more circuits are to:
identify, in at least one second grid comprising a plurality of second cells, at least one region corresponding to the one or more first occupied cells, at least one second cell of the plurality of second cells smaller than at least one first cell of the plurality of first cells;
map the one or more combinations to one or more second cells of the plurality of second cells outside of the at least one region to identify one or more second occupied cells of the plurality of second cells outside of the at least one region; and
determine the data structure according to the plurality of first occupied cells and the plurality of second occupied cells.

12. The system of claim 10, wherein the one or more circuits comprise a plurality of first circuits to determine the plurality of combinations, wherein each of the first circuits is communicatively coupled to a second circuit to set a flag of the second circuit, the flag being indicative that a given cell is one of the plurality of occupied cells.

13. The system of claim 10, wherein each of the plurality of occupied cells is bounded by the plurality of combinations.

14. The system of claim 10, wherein at least one first polygon is a convex polygon, and the first structure is a non-convex polygon.

15. The system of claim 10, wherein the one or more circuits comprise a plurality of parallel computing circuits, each parallel computing circuit of the plurality of parallel computing circuits to independently determine a corresponding combination of the one or more combinations.

16. The system of claim 10, wherein:
the grid is a two-dimensional grid; and
each cell is a pixel of the two-dimensional grid.

17. A method comprising:
mapping, by a data processing system, one or more combinations of a plurality of first polygons identified from a first structure and a plurality of second polygons identified from a second structure, to a grid comprising a plurality of cells;
identifying, by the data processing system, one or more occupied cells of the plurality of cells, to which the one or more combinations are mapped; and
outputting a data structure indicative of the plurality of occupied cells.

18. The method of claim 17, wherein the grid is a first grid, the plurality of cells are a plurality of first cells, and the one or more occupied cells are one or more first occupied cells, and comprising:
identifying, by the data processing system, in at least one second grid comprising a plurality of second cells, at least one region corresponding to the one or more first occupied cells, wherein at least one second cell of the plurality of second cells is smaller than at least one first cell of the plurality of first cells;
mapping, by the data processing system, the one or more combinations to one or more second cells of the plurality of second cells outside of the at least one region to identify one or more second occupied cells of the plurality of second cells outside of the at least one region; and
determining, by the data processing system, the data structure according to the plurality of first occupied cells and the plurality of second occupied cells.

19. The method of claim 17, comprising:
determining the plurality of combinations; and
setting a flag indicative that a given cell is one of the plurality of occupied cells.

20. The method of claim 17, wherein each of the plurality of occupied cells is bounded by the plurality of combinations.
